(19) United States
(12) Patent Application Publication
(10) Pub. No.: US 2003/0016121 A1
(43) Pub. Date: Jan. 23, 2003

(54) System and method of identifying radio frequency tags

(75) Inventor: Bruce Carl Wall, Colorado Springs, CO (US)

Correspondence Address: Law Office of Dale B. Halling, LLC, Suite 311, 24 S. Weber Street, Colorado Springs, CO, 80903, US

(73) Assignee: EM Microelecronic - (US), Inc.

(21) Appl. No.: 09/908,280

(22) Filed: Jul. 18, 2001

(51) Int. Cl. H04Q 5/22

(52) U.S. Cl. 340/10.3

(57) ABSTRACT

A system for identifying radio frequency tags includes a radio frequency device reader for reading a plurality of radio frequency identification tags. The radio frequency device reader has a start at a predetermined bit command. The plurality of radio frequency identification tags are capable of responding to the start at a predetermined bit command.

### FIELD OF THE INVENTION

The present invention relates generally to the field of radio frequency identification tags and radio frequency device readers.

### BACKGROUND OF THE INVENTION

Radio frequency device readers and radio frequency identification tags are currently in existence. The existing readers allow the user to scan a field for radio frequency identification tags to identify each bit of every tag within the field. RF identification tags have binary identity fields that may be very long. An identity field of 32 bits is not uncommon. It is not unusual for sections of the radio frequency identification tags to be identical to sections of other tags. However, the readers and tags currently in existence require that when the reader identifies one tag, the reader must start at the first bit of each subsequent tag, even if the first several bits are the same as previously identified tags. Requiring the system to start at the beginning of each tag, instead of starting with the first unknown bit, wastes time in that the reader is duplicating effort to re-identify the previously identified digits.

Thus there is a need for a system that not only stores the known bits of each radio frequency identification tag, but also has the ability to initiate the bit identification process at the last known bit of each tag, saving time.

### BRIEF DESCRIPTION OF THE DRAWINGS

FIG. 1 is a block diagram of a system for identifying a plurality of radio frequency identification tags in accordance with one embodiment of the invention;

FIG. 2 is a flow chart of a method of identifying a plurality of radio frequency identification tags in accordance with one embodiment of the invention; and

FIG. 3 is a flow chart of a method of identifying a plurality of radio frequency identification tags in accordance with one embodiment of the invention.

### DETAILED DESCRIPTION OF THE DRAWINGS

A system for identifying radio frequency tags includes a radio frequency device reader for reading a plurality of radio frequency identification tags. The radio frequency device reader has a start at a predetermined bit command. The plurality of radio frequency identification tags are capable of responding to the start at a predetermined bit command. This capability saves time in scanning radio frequency fields because the scanner does not re-read bits that have already been identified.

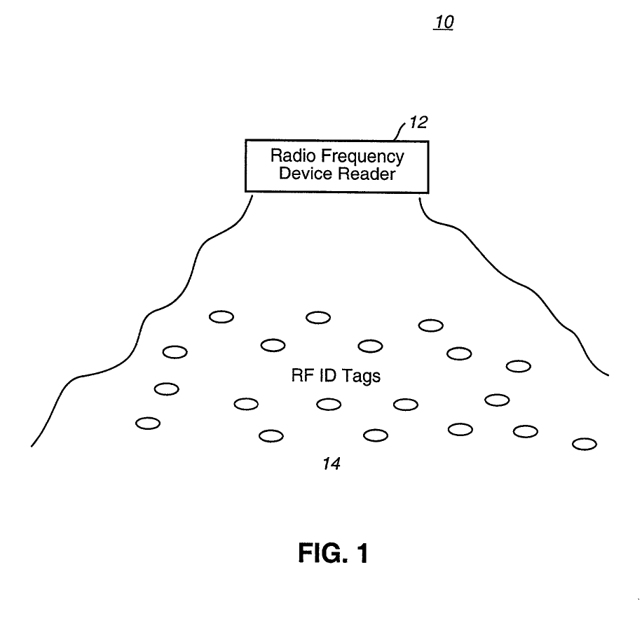

FIG. 1 is a block diagram of a system 10 of identifying a plurality of radio frequency identification tags in accordance with one embodiment of the invention. The radio frequency device reader 12 includes a “start at a predetermined bit” command. The “start at a predetermined bit” command directs the RF identification tags to transmit the predetermined bit, which can be any bit from bit 0 to bit 31 (assuming a 32 bit identity field) of the tag's identity field. This command is a new command not found in the prior art. The plurality of radio frequency identification tags 14 are capable of responding to the start at a predetermined bit command. In one embodiment, the radio frequency identification tag includes an arbitration algorithm that utilizes the start at a predetermined bit command. The arbitration algorithm identifies and stores a plurality of ambiguous bits. An ambiguous bit comprises both a 1 and a 0 response. In another embodiment, the arbitration algorithm identifies a plurality of unambiguous bits. An unambiguous bit comprises only a 1 response, or only a 0 response.

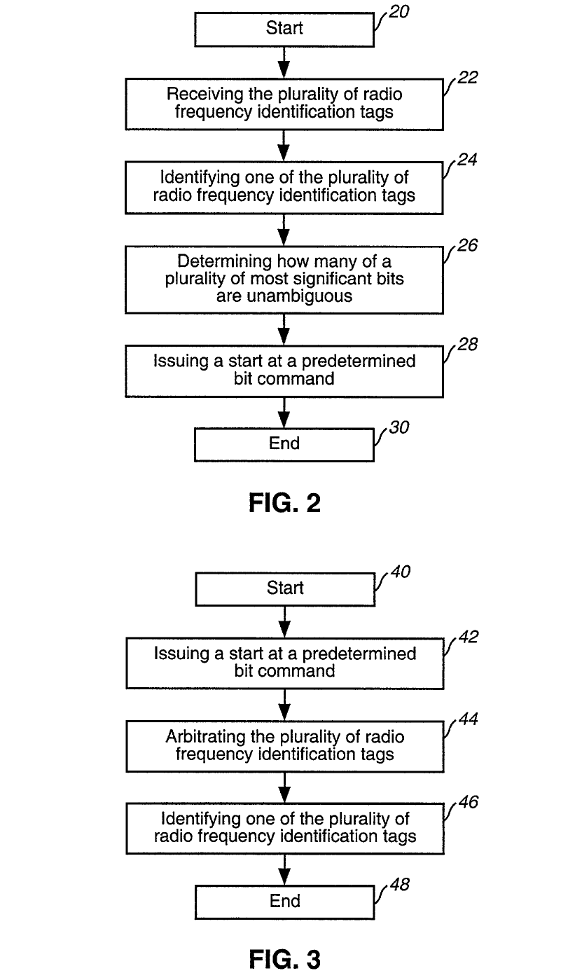

FIG. 2 is a flow chart of a method of identifying a plurality of radio frequency identification tags in accordance with one embodiment of the invention. The process starts, step 20, when a radio frequency device reader receives the plurality of radio frequency identification tags at step 22. At step 24 the RF reader device identifies one of the plurality of radio frequency identification tags and determines how many of a plurality of most significant bits are unambiguous at step 26. At step 28 the RF reader device issues a start at a predetermined bit command, which ends the process at step 30. In one embodiment, the RF device reader arbitrates the plurality of radio frequency identification tags, starting at the first ambiguous bit, and identifies another of the plurality of radio frequency identification tags. The RF device reader determines how many of a subsequent plurality of most significant bits are unambiguous, and issues the start at a predetermined bit command, where the predetermined bit is equal to a first ambiguous bit. The RF device reader then arbitrates the plurality of radio frequency identification tags. In another embodiment, the RF device reader deactivates one of the plurality of radio frequency identification tags when the tag is completely identified. The RF device reader sets the read enable bit of the completely identified radio frequency identification tag to a deactivated state (note that those skilled in the art will know the deactivated state could be 0 or 1). In another embodiment, the predetermined bit is equal to the first ambiguous bit. The RF device reader deactivates the completely identified radio frequency identification tag. In another embodiment, the RF device reader receives a plurality of most significant bits and determines if the plurality of most significant bits comprises both a 0 and a 1 response. When the plurality of most significant bits comprises both a 0 and a 1 response, the RF device reader finds ambiguity. When the plurality of most significant bits comprises only a 0 response, or only a 1 response, the RF device reader finds no ambiguity. In another embodiment, the RF device reader determines if there is ambiguity, i.e., both a “1” response and a “0” response are received. When there is ambiguity, the RF device reader remembers the level of ambiguity. When there is no ambiguity, i.e., only a “0” response or “1” response is received, the RF device reader determines if only a “0” response is received. When the response is ambiguous or when only a “0” response is received, the RF device reader issues a continue if 0 command (note that those skilled in the art will know that the response and command could be either 0 or 1). When response is unambiguous and only “1” response is received, the RF device reader issues a continue if 1 command. The RF device reader then receives a most significant bit from each of a responding plurality of transponders.

FIG. 3 is a flow chart of a method of identifying a plurality of radio frequency identification tags in accordance with one embodiment of the invention. The process starts, step 40, when an RF device reader issues a start at a predetermined bit command at step 42. The RF device reader arbitrates the plurality of radio frequency identification tags at step 44. At step 46 the RF device reader identifies one of the plurality of radio frequency identification tags, ending the process at step 48. In one embodiment, the RF device reader determines how many of a plurality of most significant bits are unambiguous and issues the start at a predetermined bit command. The RF device reader determines how many of a plurality of most significant bits are unambiguous and issues the start at a predetermined bit command. Finally, the RF device reader arbitrates the plurality of radio frequency identification tags to identify another of the plurality of radio frequency identification tags. In another embodiment, the RF device reader receives the plurality of radio frequency identification tags, and identifies one of the plurality of radio frequency identification tags. The RF device reader determines how many of a plurality of most significant bits are unambiguous. In another embodiment, the RF device reader arbitrates of the plurality of radio frequency identification tags starts at the first ambiguous bit. The predetermined bit is equal to a first ambiguous bit. In another embodiment, the RF device reader deactivates the one of the plurality of identified radio frequency identification tags.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for identifying a plurality of radio frequency identification tags comprises:
a radio frequency device reader having a start at a predetermined bit command; and
a radio frequency identification tag capable of responding to the start at a predetermined bit command.

2. The system of claim 1, wherein the radio frequency identification tag includes an arbitration algorithm that utilizes the start at a predetermined bit command.

3. The system of claim 2, wherein the arbitration algorithm identifies and stores a plurality of ambiguous bits.

4. The system of claim 2, wherein the arbitration algorithm identifies a plurality of unambiguous bits.

5. The system of claim 3, wherein an ambiguous bit comprises both a 1 and a 0 response.

6. The system of claim 3, wherein an unambiguous bit comprises only a 1 response, or only a 0 response.

7. A method for identifying a plurality of radio frequency identification tags comprising the steps of:
(a) receiving the plurality of radio frequency identification tags;
(b) identifying one of the plurality of radio frequency identification tags;
(c) determining how many of a plurality of most significant bits are unambiguous;
(d) issuing a start at a predetermined bit command.

8. The method of claim 7, further comprising the steps of:
(e) arbitrating the plurality of radio frequency identification tags, starting at the first ambiguous bit;
(f) identifying another of the plurality of radio frequency identification tags;
(g) determining how many of a subsequent plurality of most significant bits are unambiguous;
(h) issuing the start at a predetermined bit command, where the predetermined bit is equal to a first ambiguous bit;
(i) arbitrating the plurality of radio frequency identification tags.

9. The method of claim 7, wherein step (b) further includes:
(b1) deactivating one of the plurality of radio frequency identification tags.

10. The method of claim 9, wherein step (b1) further includes:
(i) setting the read enable bit of the completely identified radio frequency identification tag to a deactivated state.

11. The method of claim 7, where the predetermined bit is equal to the first ambiguous bit.

12. The method of claim 8, wherein step (f) further includes:
(f1) deactivating the completely identified radio frequency identification tag.

13. The method of claim 7, wherein step (c) further includes the steps of:
(c1) receiving a plurality of most significant bits;
(c2) determining if the plurality of most significant bits comprises both a 0 and a 1 response;
(c3) when the plurality of most significant bits comprises both a 0 and a 1 response, finding ambiguity;
(c4) when the plurality of most significant bits comprises only a 0 response, or only a 1 response, finding no ambiguity.

14. The method of claim 7, wherein step (c) further includes the steps of:
(c1) determining if there is ambiguity;
(c2) when there is ambiguity, remembering the level of ambiguity;
(c3) when there is no ambiguity, determining if only “0” is received;
(c4) when response is ambiguous or when only “0” is received, issuing a continue if “0” command;
(c5) when response is unambiguous and only “1” is received, issuing a “continue if 1” command;
(c6) receiving a most significant bit from each of a responding plurality of transponders.

15. A method for identifying a plurality of radio frequency identification tags comprising the steps of:
(a) issuing a start at a predetermined bit command;
(b) arbitrating the plurality of radio frequency identification tags; and
(c) identifying one of the plurality of radio frequency identification tags.

16. The method of claim 15, further including the steps of:
(d) determining how many of a plurality of most significant bits are unambiguous;
(e) issuing the start at a predetermined bit command;
(f) arbitrating the plurality of radio frequency identification tags to identify another of the plurality of radio frequency identification tags.

17. The method of claim 15, wherein step (a) further includes the steps of:
(a1) receiving the plurality of radio frequency identification tags;
(a2) identifying one of the plurality of radio frequency identification tags;
(a3) determining how many of a plurality of most significant bits are unambiguous.

18. The method of claim 15, wherein the arbitration of the plurality of radio frequency identification tags starts at the first ambiguous bit.

19. The method of claim 16, wherein the predetermined bit is equal to a first ambiguous bit.

20. The method of claim 15, wherein step (c) further includes the step of:
(c1) deactivating the one of the plurality of identified radio frequency identification tags.
